(19) United States
(12) Patent Application Publication
(10) Pub. No.: US 2017/0127877 A1
(43) Pub. Date: May 11, 2017

(54) Device and Method for Producing and Dispensing a Boiling Liquid and Apparatus for Preparing a Beverage Provided with Such a Device

(71) Applicant: SEB S.A., Ecully (FR)

(72) Inventor: Laurent GUEGAN, Lornay (FR)

(21) Appl. No.: 15/312,865

(22) PCT Filed: May 11, 2015
(86) PCT No.: PCT/FR2015/051236

§ 371 Date: Nov. 21, 2016

(30) Foreign Application Priority Data
May 23, 2014 (FR) 1454672

(51) Int. Cl. A47J 31/54; A47J 31/56

(52) U.S. Cl. CPC A47J 31/545; A47J 31/56

(57) ABSTRACT

Provided is a device (2) for producing and dispensing a boiling liquid including: a vessel (3); a heating system (4); a supply system (8) for supplying liquid from the vessel to the heating system; a dispensing system (13) configured to separate the boiling liquid and the steam resulting from said boiling, in order to dispense the boiling liquid and to discharge the steam; a first system for measuring the temperature of the liquid in the heating system; a system (24) for measuring the amount of steam discharged; and a system for controlling the supply system configured such as to control the flow of liquid supplying the heating system in accordance with said measurements of temperature and amount of steam discharged. Also provided is a method for producing and dispensing boiling liquid and to an apparatus (I) for preparing a beverage provided with such a device.

This invention concerns a device and method for producing and dispensing boiling liquid. It also concerns an apparatus for preparing a beverage provided with such a device and implementing said method. The present invention is intended to provide boiling liquid continuously and in a controlled manner, optimizing the safe use of this device and, therefore, the apparatus. In one application, the apparatus is a hot water fountain.

The applicant has already developed a device for producing and dispensing boiling liquid and an apparatus for preparing beverages provided with such a device, which are described in the patent application published under number FR 2 983 692 A1 .

The device according to FR 2 983 692 A1 includes a storage tank for the liquid, a liquid heating system to bring it to a boil, a liquid supply system configured to extract the liquid from the tank and deliver it into heating system. The supply system includes a pump and supply conduit connected between the tank and the pump and between the pump and the heating system. Activation of the pump makes it possible to draw out the liquid, which is at more or less ambient temperature in the tank, and deliver this liquid at a certain flow rate into the heating system where it is brought to boiling.

In addition, the device according to FR 2 983 692 A1 includes a dispensing system configured at the outlet of the heating system to separate the boiling liquid and steam arising from this boiling. The dispensing system is also configured to dispense boiling liquid through a dispensing conduit equipped with an orifice through which said boiling liquid exits. This dispensing system is also configured to evacuate the steam through an exhaust conduit to the tank, where said steam is transformed back into liquid through condensation. Furthermore, the dispensing system of the device is configured to purge all boiling liquid coming out of the heating system when the supply system stops, which prevents stagnation of the liquid in the dispensing system and mixing of the boiling liquid and liquid cooled to ambient temperature, during the next use of said device.

Despite the aforementioned advantages provided by the device for producing and dispensing boiling liquid described in patent application FR 2 983 692 A1, it can present the inconvenience of difficulty bringing the liquid to a boil or, on the contrary, releasing a large amount of steam that can burn users. The same is generally true for all devices for producing and dispensing boiling liquid known in the prior art.

In fact, devices for producing and dispensing boiling liquid known in the prior art are subject to functional differences, notably related to the manufacturing limits of their components. For example, the output of the heating element of the heating system and that of the dispensing system pump, for the same type of device, can present operational variations on the order of 15% to 20%. In addition, the same device can function differently according to variations in the voltage of the electricity supplier's network and in users' homes, and according to temperature variations of the water in the tank, depending on the ambient temperature. These parameters influence the heating of the liquid, which can have difficulty reaching boiling or, on the contrary, produce too much steam.

The present invention mitigates these inconveniences of the prior art. For this purpose, the invention concerns a device for producing and dispensing boiling liquid, which includes a liquid storage tank, liquid supply system, liquid heating system and a boiling liquid dispensing system. The liquid storage tank holds a rather large amount of liquid at roughly ambient temperature, for example 0.5 to 2 liters, so that said device can be used several times before it is necessary to refill the tank. Of course, the tank may be replaced by any other liquid supply system. For example, when this liquid is water, the device can be attached directly to the water supply network. Therefore, in one embodiment, the liquid supply system could use the pressure of that network and have, in particular, a valve controlled electrically based on a measurement of the water flow. The heating system for the liquid is configured to contain an amount of liquid and to heat this liquid to bring it to boiling. The liquid supply system is configured to extract the liquid from the tank and deliver this liquid into the heating system. The dispensing system is configured at the outlet of the heating system to separate the boiling liquid and the steam from this boiling, in order to dispense the boiling liquid and evacuate the steam. Such characteristics are known to persons skilled in the art, specifically from patent application FR 2 983 692 A1 filed by the applicant.

It is notable that, according to the invention, the device includes a first temperature measurement system to measure the temperature of the liquid in the heating system. Measuring the temperature of the liquid is understood to mean measuring a parameter representative of the temperature of the liquid. This makes it possible to determine whether the liquid in the heating system reaches its boiling temperature. Similarly, the device includes a system to measure the amount of steam evacuated, which makes it possible to detect and establish a threshold for the amount of steam produced. Measuring the amount of steam evacuated is understood to mean measuring a parameter representative of the amount of steam evacuated. In addition, the device contains a system for managing the supply system configured to regulate the flow of liquid supplying the heating system based on the temperature measured by the first measurement system and the measured amount of evacuated steam.

It is essential to regulate the flow of liquid sent into the heating system in order to mitigate the tolerances of the different operational parameters of the device, notably output variations of the heating system and flow from the pump, as well as electric voltage variations of the consumer's network and temperature variations of the liquid in the tank. Regulating the flow prevents it from being too fast, which would have the consequence of the liquid not reaching boiling, or on the contrary, it being too slow, which would have the consequence of producing too much steam. Measurement of the temperature of the liquid heated by the first measurement system ensures boiling of this liquid, which makes it possible for the management system to act on the supply system so as to reduce the flow of the liquid supply until it reaches a temperature reading corresponding to the boiling temperature of said liquid. When the flow of liquid is too slow, the liquid present in the heating system rises more easily to boiling, which produces more steam without the temperature of the liquid increasing, given that the boiling temperature is reached. Hence the importance of the ability to quantify the steam produced by the boiling liquid leaving the heating system. When a threshold for the amount of evacuated steam is reached, the management system acts on the supply system to increase the supply flow of the liquid. This regulation makes it possible to dispense a liquid at boiling temperature, or very close to boiling temperature, while limiting the amount of steam produced.

In a preferred embodiment of the device according to the invention, the system to measure the amount of steam evacuated consists of a second temperature measurement system to measure the temperature in a steam evacuation area. This second temperature measurement system enables quantification of the steam produced by the heating system based on the temperature of the mixture of steam and ambient air present in the evacuation area. When the amount of steam is low, the temperature read by the second temperature measurement system is that of the air and steam mixture and it is lower than a temperature threshold. On the other hand, when the amount of steam is too great, the temperature read by the second temperature measurement system is that of the steam only, and it is higher than said temperature threshold. In addition, the management system is configured to act on the supply system to regulate the flow of liquid supplying the heating system based on the temperatures measured by the first and second temperature measurement systems, respectively. The implementation of other technical systems making it possible to quantify the steam produced by the device is possible without going beyond the scope of the invention.

In a preferred execution mode of the device according to the invention, the second temperature measurement system is located near the open air outlet in the evacuation area, so that said second measurement system measures the temperature of an air/steam mixture when the production of boiling liquid is stabilized with low steam production.

In a preferred execution mode of the device according to the invention, the management system is configured to regulate the flow of liquid so that the temperature measured in the heating system is over 98° C. and the temperature measured in the evacuation area is between 75° C. and 95° C. Other temperature thresholds could be established, notably with respect to the temperature measured in the evacuation area, according to the amount of steam one wishes to produce or tolerate, which may depend on the configuration of the device.

In a preferred embodiment mode of the device according to the invention, the second temperature measurement system contains a temperature sensor made of a negative temperature coefficient (NTC) thermistor. Other temperature measurement systems configured to be installed on the device could be implemented without going beyond the scope of the invention.

Advantageously, the first temperature measurement system contains a temperature sensor also made of a negative temperature coefficient (NTC) thermistor.

In a preferred execution mode of the device according to the invention, the supply system includes a pump, an upstream supply conduit connected between the tank and the pump, and a downstream supply conduit connected between the pump and the heating system. Other liquid supply system implementations are possible without going beyond the scope of the invention, according to the configuration of the device.

In a preferred execution mode of the device according to the invention, the heating system includes a tubular heating chamber provided with a means of heating the liquid inside said chamber. Other heating system implementations are possible without going beyond the scope of the invention, according to the configuration of the device.

According to one execution mode of the device that is the subject of the invention, the dispensing system includes a conduit for dispensing boiling liquid provided with an outlet. In addition, a steam evacuation area is located around said outlet. This presents the advantage of reheating the air/steam mixture at the outlet, thereby delaying the temperature loss of the dispensed liquid, which leaves the device boiling, or at a temperature very close to boiling. According to one execution mode of the device that is the subject of the invention, the dispensing system is configured so that all of the boiling liquid is dispensed. This presents the advantage of preventing the stagnation of liquid in the outlet of the heating chamber, which can cause the proliferation of bacteria. This also ensures that only boiling liquid is dispensed, with no risk of being mixed with cooled liquid stagnating in the dispensing system.

In a preferred embodiment of the device according to the invention, the management system is configured to activate the supply system at the beginning of a new operation cycle so as to supply the heating system with liquid at a constant flow rate below a reference flow rate, for a defined period on the order of 15 seconds. This reference flow rate is recorded by the management system at the end of a previous operation cycle. After this defined period has lapsed, the management system activates the supply system to regulate the flow rate of liquid supplying the heating system. This enables thermal stabilization of the device prior to beginning regulation of the flow rate.

The invention also concerns a method for producing and dispensing boiling liquid. The method includes an initial step of heating a liquid, which is supplied from a tank. The heating step is realized by means of a heating system that brings the liquid to boiling. The supply of the liquid, from its storage location in the tank to the heating system, is realized by means of a liquid supply system, consisting notably of a pump and supply conduit connecting the pump to the tank upstream, and to the heating system downstream. The method includes a second step of dispensing boiling liquid and evacuating the steam arising from said boiling liquid after separating said boiling liquid from the steam. This step is implemented by means of a dispensing system configured for these purposes.

Notably, according to the invention, the method includes a step of measuring the temperature of the liquid while it is heating, realized by means of a first temperature measurement system arranged in the heating system, or right at the outlet of the heating system. The method also includes a step of measuring the amount of steam evacuated, which is realized by means of a system to measure the amount of steam evacuated. Preferably, these two measurement steps are carried out simultaneously. The method then includes a step of regulating the supply flow rate of the liquid to be heated, based on said temperature and steam evacuation measurements. This regulation of the supply flow of the liquid is implemented by means of a management system that obtains and analyzes the temperature and steam evacuation measurements and then acts on the liquid supply system to regulate the flow and dispense boiling, or very close to boiling, liquid by controlling the amount of steam evacuated, which is preferably small to prevent the risk of burns.

In a preferred execution mode of the method according to the invention, the temperature of the steam present in an evacuation area is measured, with said temperature being representative of the amount of steam evacuated, and the liquid supply flow is regulated based on said temperature measurement representative of the amount of steam evacuated, as a complement to the temperature measurement of the heated liquid. Therefore, the system for measuring the amount of steam evacuated is implemented by means of a temperature measurement system located in an evacuation area, with the management system analyzing the temperature measurement of the air and steam mixture in this evacuation area in order to quantify the steam produced by the boiling liquid in the heating system, which is then evacuated.

In a preferred embodiment of the method according to the invention, the flow is regulated so that the liquid is heated to a temperature on the order of 100° C., specifically a minimum of 98° C., and so that the temperature measured in the evacuation area, and more precisely of the air/steam mixture as will be explained later, remains between 75° C. and 95° C. Regulation of the flow could also be modified based on the desired temperature of the steam in the evacuation area, which is proportional to the amount of steam produced and evacuated. Preferably, according to the method that is the subject of the invention, the flow from a pump connected between the tank and a liquid heating system is regulated.

According to the method that is the subject of the invention, the value of a reference flow rate corresponding to the flow rate of the liquid at the end of an operation cycle is recorded. At the beginning of a new operation cycle, the flow rate of the liquid is regulated at a constant value below the reference flow rate, for a determined period. After the determined period lapses, the flow rate is regulated based on the temperature of the heated liquid and amount of steam evacuated, until the end of the cycle.

The present invention also concerns an apparatus for preparing a beverage provided with such a device and implementing said method. In one embodiment mode, this apparatus is a hot water fountain.

The following description of an execution mode of an apparatus for preparing a beverage shows the characteristics and advantages of the present invention. This description is based on figures, which include:

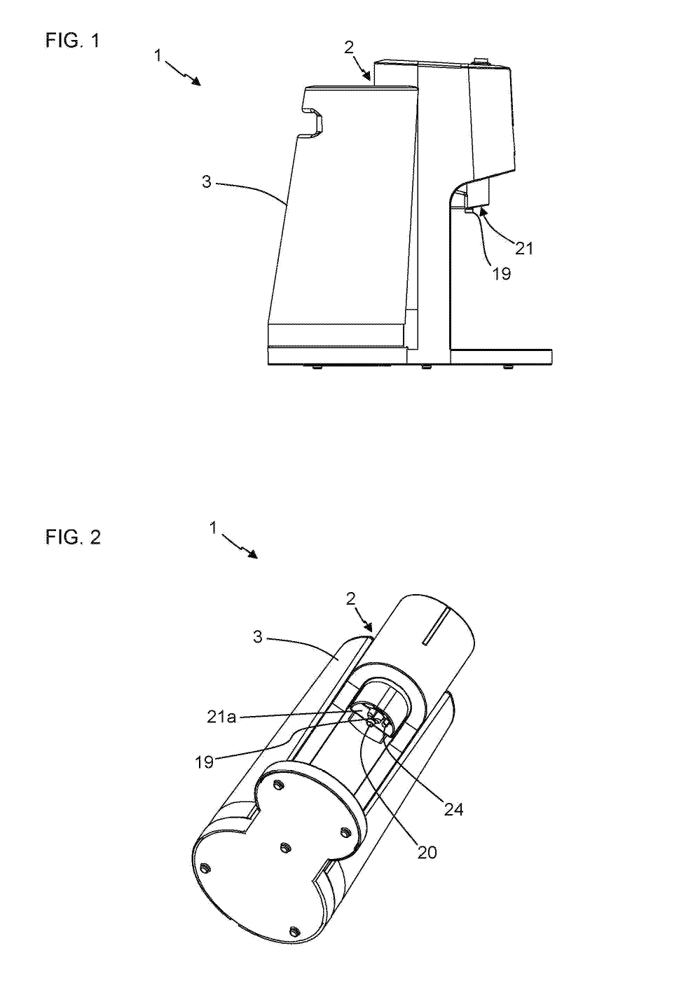

FIG. 1 illustrates a side view of a hot water fountain,

FIG. 2 illustrates a three-dimensional view of the fountain and shows specifically a heated liquid dispensing outlet and a steam evacuation area arranged on this fountain;

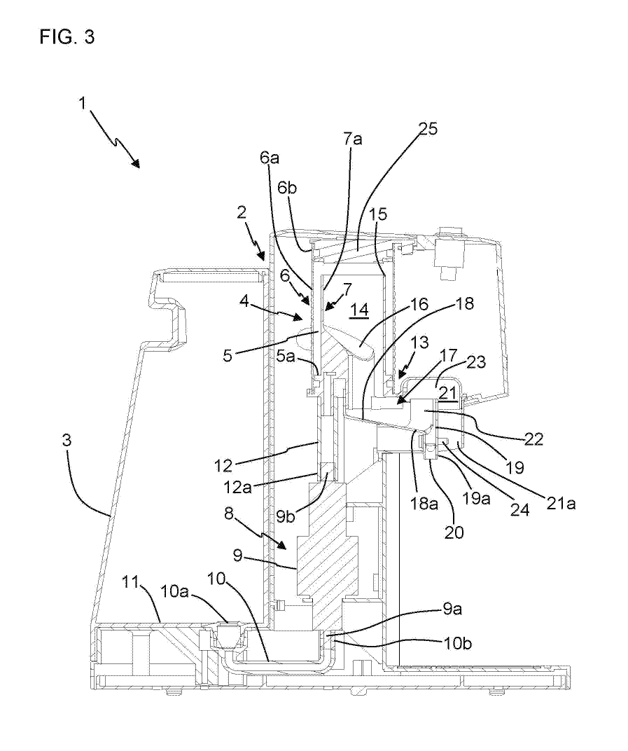

FIG. 3 illustrates a side cross-section view of the fountain.

In the rest of the description, the liquid in question is water, which has a boiling point of 100° C. under normal atmospheric conditions. In practice, the liquid used will generally be water due to issues of cleaning the inside of the apparatus for preparing beverages. In fact, it would be very problematic to use it with liquids such as milk, which would stick to it. However, other liquids are possible without going beyond the scope of the invention, in particular liquids consisting of a mixture with a high concentration of water, and provided the apparatus is configured to be cleaned easily.

FIGS. 1 to 3 illustrate a hot water fountain 1, which has a device 2 to produce and dispense water that is boiling, or at a temperature very close to boiling. The device according to the invention has many characteristics similar to those of the device described according to the different variations in patent application FR 2 983 692 A1 filed by the applicant. Persons skilled in the art could therefore draw from the teachings of this patent application FR 2 983 692 A1 to implement the device 2 according to the invention.

The device 2 includes a water storage tank 3, which has a water storage capacity between 0.5 liters and 2 liters, for example. In other fountain designs also covered by this invention, the tank 3 can be replaced by a direct connection to a faucet connected to the water supply network by means of a flexible tube, for example. In this case, the apparatus would be configured to manage the pressure from the water distribution system.

The device 2 includes a water heating system 4, which has a tube-shaped heating chamber 5, which has an external tube 6 and an internal tube 7. This heating chamber 5 includes a means of heating (not illustrated in detail in the figures), which brings to a boil water placed inside this heating chamber 5. This means of heating consists, for example, of screen-printed tracks, as described in patent application FR 2 983 692 A1, arranged on the external wall 6a of the external tube 6. Other means of heating are possible, such as for example positive temperature coefficient (PTC) thermistors or a resistive external tube 6 configured to be heated entirely. Screen-printed tracks are favored, however, so that the apparatus has optimal instantaneous heating characteristics.

The device 2 includes a water supply system 8 for said heating system 4 from the tank 3. The supply system 8 includes a pump 9. An upstream supply conduit 10 opens at its first end 10a in the bottom 11 of the tank 3 and is connected at its second end 10b at the inlet 9a of the pump 9. A downstream supply conduit 12 is connected at its first end 12a to the outlet 9b of the pump 9 and opens at its second end 12b into the heating chamber 5.

The device 2 includes a dispensing system 13, which includes a cavity 14 delineated by the internal wall 7a of the internal tube 7. The upper edge 15 of the internal tube 7 is open, which enables the cavity to be in contact with the heating chamber 5, as FIG. 3 illustrates. Activation of the pump 9 permits the injection of water into the heating chamber 5. Going up into this heating chamber 9, the water heats until reaching its boiling point. This boiling makes the water rise toward the top of the heating chamber 5 until it reaches the upper edge 15 of the internal tube 7, where the boiling water falls due to gravity into the cavity 14. The bottom 16 of the cavity 14 is open and forms a channel inclining toward the back, which enables all the boiling water contained in the cavity 14 to drain with a buffering effect. The external tube 6 of the heating chamber 5 is closed at its top edge 6b by means of a cover 25, as illustrated in FIG. 3, which prevents the steam leaving the heating chamber 5 from escaping through the top of the device 2. This steam is therefore forced to escape by passing through the cavity 14. The dispensing system 13 includes a chamber 17 into which the open bottom 16 of the cavity 14 leads. This chamber 17 is configured to separate the boiling water and the steam. For this, the chamber 17 includes a drainage wall 18 in the form of a sloping channel that has a waterfall effect with the bottom 16. This drainage wall 18 opens at its lower portion 18a onto a nozzle 19, which has on its end 19a an orifice 20 for dispensing boiling water. The sloping shape of the drainage wall 18 ensures extraction of all the boiling water. This chamber 17 delineates an enclosure 21 open at its lower portion 21a so as to lead to the exterior of the device 2. The nozzle 19 is located in this lower portion 21a of the enclosure 21 as illustrated in FIGS. 2 and 3. At the end of the lower portion 18a of this drainage wall 18, around the nozzle 19, there is a vertical curved separation wall 22 that forms a barrier to the drainage of the boiling water at the end of the drainage wall 18, which forces the boiling water to drain through said nozzle 19. The position of the separation wall 22 at the edge of the nozzle 19 prevents the stagnation of water at this location. This separation wall 22 extends in the vertical portion to the inside of the enclosure 21 so as to leave a passage 23 that enables, first, separation of the steam and boiling liquid, and second, propagation of this steam into the enclosure 21. Therefore, the enclosure 21 constitutes an evacuation area for the steam. The steam is evacuated to the exterior of the device 2 through the open lower portion 21a of the enclosure 21, while the boiling water exits through the dispensing orifice 20, through this open lower portion 21a. Evacuation of the steam makes it possible to heat the external environment located around the dispensing orifice 20, which reduces and delays the heat loss of the boiling water while it is dispensing.

The heating chamber 5 is equipped with a first temperature sensor measuring the temperature T1 of the liquid while it is heating. This first temperature sensor preferably consists of a negative temperature coefficient (NTC) thermistor (not illustrated in the figures), which is located, for example, on the external wall 6a in the upper part of the external tube 6, in order to read the temperature in the boiling area.

Similarly, as illustrated in FIGS. 2 and 3, a second temperature sensor 24 is located in the lower portion 21a of the enclosure 21 beside of the nozzle 19. The second temperature sensor 24 is preferably a negative temperature coefficient (NTC) thermistor and measures the temperature T2 of the air and steam mixture in the enclosure 21, which is open at its lower portion 21a. In fact, the position of the second temperature sensor 24 beside the nozzle 19, near the open air outlet, makes it possible to measure the temperature of an air/steam mixture while the production of boiling liquid is stabilized with low steam production. If this second sensor 24 was positioned too far inside of the apparatus 1, it would only measure the steam, and therefore a temperature T2 around 100° C. irrespective of the flow of steam. On the contrary, when it is positioned close to the open air outlet, the steam mixes with air and this mixture is what is measured. A heavy flow of steam then drives the air out of the open air outlet completely, and the second temperature sensor 24 may read up to about 100° C., while a low steam flow rate enables air to mix with this steam and lower the average temperature. The device 2 also includes a circuit board type of management system (not illustrated in the figures), which receives temperature measurements T1 and T2 from the first temperature sensor (not illustrated) located in the heating chamber 5 and from the second temperature sensor 24 in the lower portion 21a of the enclosure 21, respectively. This circuit board is connected to the pump 9 and acts on it so as to modify the flow from this pump 9 based on the temperatures T1 and T2 measured.

The water rises to boiling at the temperature T0, which under normal usage conditions of the device (at normal atmospheric pressure), is 100° C. The management system compares the temperature T1 measured in the heating chamber 5 to the boiling temperature T0. As long as the temperature T1 has not reached this temperature T0, the management system acts on the pump 9 to reduce the flow of water so as to slow the supply of cold water to the heating chamber 5 and enable the water present in this heating chamber—in the process of heating—to go up to boiling.

If the management system reduces the flow from the pump 9 too much, the boiling water in the heating chamber 5 will produce more steam without the temperature T1 increasing, given that it has reached the boiling temperature T0. This is why the management system simultaneously compares the temperature T2, measured in the lower portion 21a of the enclosure 21, to a reference temperature T3 so as to quantify the steam present in the lower portion 21a of the enclosure 21.

When the steam flow is low, the temperature T2 picked up by the second temperature sensor 24 corresponds to an average of the ambient air temperature, located near this open lower portion 21a, and the temperature of the steam itself, which is evacuated. As long as the temperature T2 measurement is below this reference temperature T3, without going below a temperature threshold preferably set at 75° C., and the water heating temperature T1 is at the temperature T0, the management system considers the flow from the pump to be correct and maintains this flow. On the contrary, when the steam flow rate is too high, the temperature T2 picked up by the second temperature sensor 24 is closer to that of the steam itself. As soon as the temperature T2 measurement goes beyond the reference temperature T3, the management system acts on the pump 9 to increase its water supply flow rate so as to cool slightly the water in the heating chamber 5, and thereby reduce the production of steam. Simultaneously, the management system continues to compare the temperature T1 of the heated water in the heating chamber 5 so as to regulate the flow from the pump 9 and keep this water boiling, or near boiling, without going below a temperature threshold preferably set at 98° C. Preferably, the reference temperature T3 is set at 95° C.

Persons skilled in the art will use general knowledge in the field of electronics to implement a circuit board programmed to regulate the flow from the pump 9 based on the temperature T1 and T2 measurements, and according to the process described previously.

Therefore, the management system makes it possible to manage the heating system 4 and supply system 8 so that the temperature seen by the temperature sensor on said heating system 4 remains over 98° C. and so that the temperature of the air/steam mixture seen by the temperature sensor 24 remains between 75° C. and 95° C., which ensures that boiling, or close to boiling, water is dispensed without the overproduction of steam at the outlet.

The management system is programmed so that, upon initial activation of the apparatus 1, the device 2 performs a self-calibration of the flow from the pump 9, which is adjusted automatically based on the temperature T2 measurement in the lower portion 21a of the enclosure 21, proportional to the amount of steam produced. This flow rate is recorded by the management system as the reference flow rate D0. Upon the next activation of the apparatus 1, the management system regulates the flow from the pump 9 at a constant flow rate D1 slightly below the reference flow D0 for a defined period d1, preferably 15 seconds, so as to enable thermal stabilization of the device 2. After this period d1 has lapsed, the management system begins to regulate the flow from the pump 9 in order to maintain a temperature T1 of the heated water roughly equal to the boiling temperature T0, on the order of 100° C., and a temperature T2 of the air and steam mixture in the lower portion 21a of the enclosure 21 below the reference temperature T3, on the order of 95° C. At the end of the operation cycle, the management system is configured to record the last flow rate D0(n) regulation value, which becomes the new reference. At the beginning of each new cycle (n+1), the management system adjusts the flow from the pump 9 to a constant flow rate D1(n+1) slightly below a reference flow D0(n) for the duration d1, prior to beginning regulation of the flow from the pump 9. And so on. The management system circuit board will be programmed to fulfill these functions.

Implementation variations are possible without going beyond the scope of the invention. Specifically, the steam in the enclosure 21 can be quantified differently. For example, a pressure sensor (not illustrated) can be placed in the enclosure 21, replacing the second temperature sensor 24, with the management system being configured to quantify the steam based on the pressure measured in the enclosure 21. However, the implementation mode described previously will be favored due to manufacturing cost issues.

It is also possible to implement the invention on variations of devices described in patent application FR 2 983 692 A1 filed by the applicant, which differ from the device 2 described previously due to the fact that the dispensing system is arranged so that the steam is evacuated into the tank. According to the different variations described in FR 2 983 692 A1, it would be suitable to position the second temperature sensor 24, cited previously, judiciously in an area to which steam is evacuated prior to its ejection into the tank.

Other water supply systems are also possible, positioned between the tank 3 and the heating system 4, according to the configuration of the device 2. For example, pump 9 could be replaced by an electrically controlled valve placed in a supply conduit, which would be connected upstream directly to the electrical system and downstream to the heating chamber 5. In this case, the heating system would activate the valve to regulate the flow of water supplying the heating chamber 5. An electrically controlled valve would be preferable, for example, to a pump 9 in the case where the tank 3 is replaced by a direct connection to a faucet connected to the water supply network, as described previously, in order to manage the water pressure.

1. Device for producing and dispensing boiling liquid comprising:
a liquid storage tank,
a liquid heating system,
a liquid supply system configured to extract liquid from the tank and deliver it to the heating system,
a dispensing system configured at the outlet of the heating system to separate boiling liquid and steam arising from the boiling liquid, in order to dispense the boiling liquid and evacuate the steam,
wherein the device further includes:
a first temperature measurement system to measure the temperature of the liquid in the heating system,
a measurement system to measure an amount of steam evacuated,
and a supply system management system configured to regulate the flow of liquid supplying the heating system based on the temperature measured by the first measurement system and on the amount of steam evacuated.

2. Device according to claim 1, in which:
the system to measure the amount of steam evacuated consists of a second temperature measurement system to measure the temperature in a steam evacuation area,
the supply system management system is configured to regulate the flow of liquid supplying the heating system based on temperatures measured by the first and second temperature measurement systems.

3. Device according to claim 2, in which the second temperature measurement system is arranged near an open air outlet in an evacuation area so that said second system measures the temperature of an air/steam mixture when the production of boiling liquid is stabilized with low steam production.

4. Device according to claim 2, in which the management system is configured to regulate the flow so that the temperature in the heating system is over 98° C. and the temperature in the evacuation area is between 75 and 95° C.

5. Device according to claim 2, in which the second temperature measurement system contains a temperature sensor consisting of a negative temperature coefficient (NTC) thermistor.

6. Device according to claim 1, in which the liquid supply system includes a pump, an upstream supply conduit connected between the storage tank and the pump and a downstream supply conduit connected between the pump and the heating system.

7. Device according to claim 1, in which the heating system includes a tubular heating chamber equipped with a means of heating.

8. Device according to claim 1, in which the dispensing system includes a boiling liquid dispensing system, provided with an outlet, with a steam evacuation area located around said outlet.

9. Device according to claim 1, in which the dispensing system is configured so that all of the boiling liquid is dispensed.

10. Device according to claim 1, in which the management system is configured to activate the supply system at a beginning of a new operation cycle, by supplying the heating system with liquid at a constant flow rate below a reference flow rate recorded by the management system at the end of a previous operation cycle, for a defined period, and then to begin flow regulation.

11. Method for producing and dispensing boiling liquid, including:
heating liquid supplied from a tank in order to bring said liquid to boiling,
dispensing the boiling liquid and evacuating the steam emanating from said boiling liquid, after having separated said boiling liquid from the steam,
wherein the method further includes:
measuring a temperature of the liquid while it is heated,
measuring an amount of steam evacuated,
and regulating the supply flow of the liquid to be heated based on said temperature measurement and said measurement of the amount of steam evacuated.

12. Method according to claim 11, including the steps of:
measuring the temperature of the steam present in an evacuation area, with said temperature being representative of the amount of steam evacuated, and
regulating a supply flow rate of the liquid based on said temperature measurement representative of the amount of steam evacuated and the temperature measurement of the heated liquid.

13. Method according to claim 12, in which the flow is regulated so that the liquid is heated to a temperature of 100° C. and the temperature measured in the evacuation area remains between 75° C. and 95° C.

14. Method according to claim 11, in which the flow is regulated from a pump connected between the tank and a heating system for the liquid.

15. Method according to claim 11, in which:
the value of a reference flow rate corresponding to the flow rate of the liquid at the end of an operation cycle is recorded;
at the beginning of a new operation cycle, the liquid flow is regulated at a constant value below the reference flow rate for a determined period;
after the determined period lapses, the flow is regulated based on the temperature of the heated liquid and amount of steam evacuated until the end of the cycle.

16. Apparatus for preparing beverages, which includes a device for producing and dispensing boiling liquid according to claim 1.
